(19) United States
(12) Patent Application Publication
(10) Pub. No.: US 2015/0103336 A1
(43) Pub. Date: Apr. 16, 2015

(54) OPTICAL CONNECTOR MONITORING

(71) Applicant: REFLEX PHOTONICS INC., Pointe-Claire (CA)

(72) Inventors: David Robert Cameron Rolston, Beaconsfield (CA); Brian Mink, Pierrefonds (CA); Shao-Wei Fu, Delson (CA)

(21) Appl. No.: 14/403,726

(22) PCT Filed: May 30, 2013
(86) PCT No.: PCT/CA2013/000531

§ 371 Date: Nov. 25, 2014

Related U.S. Application Data
(60) Provisional application No. 61/652,947, filed on May 30, 2012.

(51) Int. Cl. G01M 11/00; G01J 1/04; G02B 6/42

(52) U.S. Cl. CPC G01M 11/33; G02B 6/42; G01J 1/0425
USPC 356/73.1

(57) ABSTRACT

There is described an optical connector comprising a casing having a hollow body and at least one aperture at one end thereof, at least one optical fiber having an outer surface and a fiber end and extending inside the hollow body of the casing along a longitudinal direction thereof, a connector assembly supporting the at least one optical fiber in the casing and aligning the fiber end with the at least one aperture, and an optical monitoring device comprising at least one photodetector in proximity to the fiber end of the at least one optical fiber and adapted to detect naturally leaked light from the fiber end. An optical monitoring device and a method for monitoring optical power in an optical connector are also described.

### CROSS-REFERENCE TO RELATED APPLICATIONS

This patent application claims priority of U.S. provisional Application Ser. No. 61/652,947, filed on May 30, 2012.

### TECHNICAL FIELD

The present disclosure relates to optical connectors for light transmission using optical fibers or waveguides, embedded electronics and sensor technology, and more specifically to performance monitoring of optical connectors.

### BACKGROUND

One of the least addressed, but most costly aspects of installing a large computing or switching center continues to be the maintenance and organization of the cabling at the initial installation phase. It has been estimated that for larger system installations, such as supercomputing installations, it takes more than one man-year of effort to properly install all the cabling, where a major part of the interconnects for these systems today relies on high-speed optical fiber cabling. The two biggest issues with cable installations are due to damaged optical fiber and mislabeled or misplaced cables.

When cables do not function properly or when errors are made in their layout, this costs time and labor to correct—which can sometimes only be found during system initialization. Furthermore, optical fiber cable networks are usually installed in inconvenient locations. They must be installed rapidly and without the luxury of ultra-clean environments. Therefore, even with the most strenuous attempts to achieve “good” low-loss connections, faults in the optical fiber cabling can result in errors within the system that can typically be hard to diagnose.

In standard optical fiber cables, a small amount of optical signal attenuation, due to a dust particle or scratched optical fiber, may result in a bit error rate in the channel. This error rate may be difficult to diagnose because it might be pattern or device sensitive—and even more difficult to locate.

Placing optical cables into plenums and other structured cabling racks (in ceilings, up towers, along walls or under flooring), or outside in harsher environments, makes them susceptible to cleanliness issues. Slightly contaminated terminated optical fibers can scatter (but not totally block) light traveling along the fiber, which can complicate the diagnosis of a system's performance. Furthermore, the logistical aspect of simply keeping track of the cable within a central office or computing facility—with many thousands of cable connects—can be challenging. While optical telecommunication cabling, meant for many tens or hundreds of kilometers, is typically fusion spliced to obtain the lowest possible optical loss, many of the shorter distance data-communication optical fiber cabling requires structured-cabling systems with many mate-able (and detachable) optical connectors.

The standard manual techniques for preparing and tracking optical fiber cabling is subject to human-error during these installation steps. However, other than a few examples of prior-art that use self-wiping (e.g. self-cleaning) optical connectors, or spring-loaded shutters that prevent contamination into the optical connector, there are very few simple, low-cost, active or passive monitoring systems that can be implemented during installation and later monitored for system integrity.

There is thus a need for an improved optical connector assembly that addresses at least some of the issues associated with the prior art.

### SUMMARY

There is described herein an optical connector assembly allowing both the monitoring of the average optical power through the optical connector and a simple cable identification and classification methodology without disturbing the normal connector function. The optical power that is lost due to the imperfect connector to connector interface is monitored at the connector end and stored and/or transmitted to an external measurement device such as a scanner or diagnostic instrument.

In accordance with a first broad aspect, there is provided an optical connector comprising a casing having a hollow body and at least one aperture at one end thereof, at least one optical fiber having an outer surface and a fiber end and extending inside the hollow body of the casing along a longitudinal direction thereof, a connector assembly supporting the at least one optical fiber in the casing and aligning the fiber end with the at least one aperture, and an optical monitoring device comprising at least one photodetector in proximity to the fiber end of the at least one optical fiber and adapted to detect naturally leaked light from the fiber end.

Still in accordance with a first broad aspect, the optical monitoring device comprises a memory for recording a measurement of the naturally leaked light.

Still in accordance with a first broad aspect, the optical monitoring device comprises a transmitting apparatus for transmitting the measurement of the naturally leaked light.

Still in accordance with a first broad aspect, a coating on the at least one optical fiber captures and scatters at least a portion of the naturally leaked light at a plurality of angles along the outer surface of the optical fiber.

Still in accordance with a first broad aspect, the optical monitoring device is fitted inside the hollow body of the casing.

Still in accordance with a first broad aspect, the optical monitoring device comprises a circuit board and the at least one photodetector comprises an elongate photodetector chip mounted on the circuit board, the photodetector chip positioned adjacent the at least one optical fiber and aligned along a length thereof.

Still in accordance with a first broad aspect, the at least one photodetector comprises a first photodetector member having a first inner surface and a second photodetector member having a second inner surface, the first photodetector member and the second photodetector member arranged to define between the first inner surface and the second inner surface an elongate space receiving therein the at least one optical fiber.

Still in accordance with a first broad aspect, the first photodetector member has a first coating on the first inner surface and the second photodetector member has a second coating on the second inner surface, the first coating and the second coating capturing and scattering at least a portion of the naturally leaked light at a plurality of angles along the outer surface of the at least one optical fiber.

Still in accordance with a first broad aspect, the at least one optical fiber comprises a fiber ribbon comprising an array of parallel optical fibers.

Still in accordance with a first broad aspect, the parallel optical fibers are separated to cut-off bleed-light of adjacent ones of the parallel optical fibers.

Still in accordance with a first broad aspect, the optical monitoring device is adapted to detect the naturally leaked light from alternate ones of the parallel optical fibers.

Still in accordance with a first broad aspect, the at least one photodetector comprises a photodetector array chip covered by a plate having formed therein a plurality of parallel grooves each receiving a corresponding one of the parallel optical fibers, the naturally leaked light from the alternate ones of the parallel optical fibers imaged on the photodetector array chip.

Still in accordance with a first broad aspect, the parallel optical fibers are numbered and further wherein the plate has formed therein a first set of the plurality of parallel grooves receiving even-numbered ones of the parallel optical fibers and a second set of the plurality of parallel grooves receiving odd-numbered ones of the parallel optical fibers.

Still in accordance with a first broad aspect, at least one electromagnetic field coil is provided on the casing, the at least one electromagnetic field coil configured to modulate a magnetic field to at least one of wirelessly provide electrical power to the optical monitoring device and wirelessly transmit the measurement.

Still in accordance with a first broad aspect, at least one electrical contact is provided on the casing and configured to at least one of provide electrical power to the optical monitoring device and transmit the measurement by physical contact.

Still in accordance with a first broad aspect, there is provided a protective cable surrounding the at least one optical fiber and an electrical bus coupled to the protective cable, the electrical bus configured to at least one of provide electrical power to the optical monitoring device and transmit the measurement.

Still in accordance with a first broad aspect, the optical connector comprises at least one optical device positioned adjacent the fiber end and adapted for guiding the naturally leaked light towards the at least one photodetector.

Still in accordance with a first broad aspect, the optical connector comprises at least one optical filter positioned adjacent the fiber end and the at least one photodetector, the at least one optical fiber sensitive to a given wavelength of light and adapted to cause the at least one photodetector to detect the given wavelength of the naturally leaked light.

Still in accordance with a first broad aspect, the optical connector is one of an FC-type connector, an SC-type connector, an LC-type connector, an MU-type connector, and an MT-type connector.

In accordance with another broad aspect, there is provided an optical monitoring device for monitoring optical power in an optical connector, the device comprising a supporting member adapted to receive at least one optical fiber of the optical connector, the at least one optical fiber having an outer surface and a fiber end, and at least one photodetector secured to the supporting member, the at least one photodetector adapted to be positioned in proximity to the fiber end of the at least one optical fiber and to detect naturally leaked light from the fiber end.

Still in accordance with another broad aspect, the optical monitoring device comprises a memory for recording a measurement of the naturally leaked light and a wireless transmitting apparatus for transmitting the measurement.

Still in accordance with another broad aspect, the supporting member is adapted to be fitted inside the hollow body of the casing of the optical connector with the at least one optical fiber received on the supporting member extending inside the hollow body of the casing along a longitudinal direction thereof.

Still in accordance with another broad aspect, the at least one photodetector comprises an elongate photodetector chip adapted to be positioned adjacent the at least one optical fiber and aligned along a length thereof.

Still in accordance with another broad aspect, the at least one photodetector comprises a first photodetector member having a first inner surface and a second photodetector member having a second inner surface, the first photodetector member and the second photodetector member arranged to define between the first inner surface and the second inner surface an elongate space adapted to receive therein the at least one optical fiber.

Still in accordance with another broad aspect, the first photodetector member has a first coating on the first inner surface and the second photodetector member has a second coating on the second inner surface, the first coating and the second coating adapted to capture and scatter at least a portion of the naturally leaked light at a plurality of angles along the outer surface of the optical fiber.

Still in accordance with another broad aspect, the at least one photodetector comprises a photodetector array chip and the supporting member comprises a plate covering the photodetector array chip, the plate having formed therein a plurality of parallel grooves each receiving therein a corresponding one of parallel optical fibers, the naturally leaked light from alternate ones of the parallel optical fibers imaged on the photodetector array chip.

In accordance with another broad aspect, there is provided a method for monitoring optical power in an optical connector, the method comprising: transmitting light through at least one optical fiber having an outer surface and a fiber end and extending inside a hollow body of a casing of the optical connector along a longitudinal direction thereof, at least part of the light traveling through the at least one optical fiber leaking from the fiber end; and detecting naturally leaking light from the fiber end of the at least one optical fiber using at least one photodetector placed in proximity thereto.

Still in accordance with another broad aspect, the method further comprises recording a measurement of the naturally leaked light in a memory and transmitting the measurement to one or more receiving apparatuses using a wireless transmitting apparatus coupled to the at least one photodetector.

Still in accordance with another broad aspect, transmitting light through the at least one optical fiber comprises transmitting light through an array of parallel fibers and further wherein detecting the naturally leaking light comprises detecting the naturally leaked light from alternate ones of the parallel optical fibers imaged on the at least one photodetector.

Still in accordance with another broad aspect, the method further comprises detecting a rate at which data bits are transmitted through the at least one optical fiber using an avalanche photodiode as the at least one photodetector.

### BRIEF DESCRIPTION OF THE DRAWINGS

Further features and advantages of the invention will become apparent from the following present detailed description, taken in combination with the appended drawings, in which:

FIG. 1 is a perspective view of an FC-type optical fiber connector;

FIG. 2 is a perspective view of two FC-type optical connectors being mated together using an FC-FC adapter;

FIG. 3 is a perspective view of an FC-type optical connector being mated to standard type TO-4 can optical assemblies;

FIG. 4 is a cross-sectional side view of two in-line optical fibers and zirconia ferrules without the mechanicals of the FC-type optical connectors;

FIG. 5 is a perspective view of an optical fiber of an FC-type optical connector coupled to an optical monitoring device, in accordance with an embodiment;

FIG. 6 is a perspective view of the optical monitoring device of FIG. 5, in accordance with an embodiment;

FIG. 7 is a perspective exploded view of an optical monitoring device, in accordance with another embodiment;

FIG. 8 is a perspective, exploded view of part of an FC-type optical connector with an optical monitoring device, in accordance with an embodiment;

FIG. 9 is a perspective, exploded view of the entire FC-type optical connector with optical monitoring device of FIG. 8;

FIG. 10 is a perspective, side-by-side, comparison view of a standard FC-type optical connector and the FC-type optical connector with optical monitoring device of FIG. 9;

FIG. 11 is a bisectional side view of the FC-type optical connector with optical monitoring device of FIG. 10;

FIG. 12 is a perspective view of an FC-type optical connector with optical monitoring device, in accordance with another embodiment;

FIG. 13 is a perspective view of a generic type optical ribbon fiber connector;

FIG. 14 is a perspective view of a generic type integrated circuit package containing an array CCD chip and covered with a glass lid;

FIG. 15 is a perspective view of an integrated circuit package containing an array CCD chip and an aperture slotted plate, in accordance with an embodiment;

FIG. 16 is a perspective view of the aperture slot plate of FIG. 15;

FIG. 17 is a top view of the integrated circuit package of FIG. 15 (a) with a parallel optical fiber ribbon over-laid; and, (b) without the parallel optical fiber ribbon over-laid;

FIG. 18 illustrates (a) a top view of the array CCD chip of FIG. 15 with an indication of a location where incident light from the optical fiber ribbon of FIG. 17 would fall, (b) a plot of a light amplitude read-out along a first line (A-A′) across the array CCD chip, and (c) a plot of a light amplitude read-out along a second line (B-B′) across the array CCD chip;

FIG. 19 is a perspective view of an assembly comprising the integrated circuit package of FIG. 15 with a parallel optical fiber ribbon over-laid, a cover lid, and a ribbon cable grasping material, in accordance with an embodiment; and

FIG. 20 is a perspective view of the assembly of FIG. 19 coupled to a parallel optical fiber ribbon cable ended with an optical connector, in accordance with an embodiment.

### DETAILED DESCRIPTION

In connector-based optical connectors, independent of the style of connector (e.g. FC, SC, MU, MT), or the face-polish (e.g. FC/APC), there exists a small fraction of optical power that does not couple from the core of the transmitting optical fiber to the core of the receiving optical fiber. This can be due to many different causes such as; the eccentricity or diameter of the cores relative to each other, the Fresnel reflections at the interface, the surface roughness of the polished tip of the fiber, or other non-uniformities. Although these losses are always kept to a minimum, there is normally between −0.5 dB and −0.05 dB of optical power that is lost at the interface, the amount of power loss depending on the type of fiber, e.g. multimode or single-mode fiber, and the type of surface finish required on the optical connectors. Even the fusion-spliced optical connection, where the two ends of the optical fibers are heated and melted together to make a connector-less joint, suffers from some optical loss.

The standard method used to assemble an optical connector is to insert the 125-um diameter glass fiber into a zirconia (or ceramic) guiding cylinder, called a ferrule. The zirconia ferrule locates the glass fiber in the center of the very highly toleranced rigid ferrule. The fiber is glued in place and the end tip of the ferrule, along with the glass fiber tip, is then polished flat and smooth, whereupon an appropriate type of mechanical connector assembly is built around the ferrule.

Two of these optical connectors of the FC-type, LC-type, or other suitable connector type, can then be connected (and aligned) together using an equally well toleranced alignment barrel or coupler. In addition, a single optical connector can be connected (and aligned) using a suitable transmitting or receiving module, such as a TOSA or ROSA (transmitter/receiver optical sub-assembly) in a standard package type like a “TO-4 can” assembly, with a laser or photodetector aligned within.

At the connector interface, a large portion of light from the core of one connector may be coupled into the core of the next connector and properly carried down the glass fiber. However, some optical power is lost at this interface. As discussed above, some optical power may also be lost along the length of the fiber due to dust particles, non-uniformities, or other defects of the optical fiber. By using an acceptably sensitive photodetector, such as a charge-couple device (CCD), a large-area p-n junction photodiode, a large-area organic/polymer photoelectric material, or an avalanche photodiode (APD), or other suitable photodetector known to those skilled in the art, some of the lost light may be captured. It should be understood that, although the embodiments described herein refer to one photodetector being used as part of an optical monitoring device for detecting light leaked from an optical fiber, a single photodetector or a set of photodetectors may apply. A correlation can then be made between the amount of light lost versus the amount of light actually being passed through the connector interface. This may be done without disturbing the method in which the connectors are connected together and without the need for modifications to the glass optical fiber itself.

The manner in which the lost light is scattered along the optical fiber may further be considered in the connector assembly. Given a bare glass fiber strand that has been cleaned and is clear of any imperfections, lost light caused by the connector interface is hardly visible because it is traveling in the same general direction as the strand of glass fiber—albeit with a slight angular direction so that the rays of light are passing out of the glass fiber. A system that observes this lost light from a position perpendicular to the direction of the glass fiber strand will therefore not see much, if any, of the scattered light.

In one embodiment, a scattering mechanism on the outside diameter of the glass fiber strand may be used to detect lost light. A plastic, e.g. polyimide, protection coating applied to the optical fiber (usually with a total diameter of about 250-microns) is capable of capturing and scattering the lost light and directing a large portion of it at all angles surrounding the glass fiber. This includes scattering and directing the lost light perpendicular to the glass strand. As a result, the polyimide coating “glows” for a few centimeters along the fiber after the connector, when viewed with a CCD camera or any other suitable type of detector capable of detecting the wavelength of interest—illustratively 850-nm. Using the glowing effect allows the lost light to be measured without any direct manipulation or alteration to the pristine optical fiber.

Scattering mechanisms other than polyimide protection coatings are also possible. For example, in another embodiment, the bare glass fiber can be coated with a portion of metal or ceramic dust particles. Other, more specifically designed, patterns can also be applied to the surface of the glass fiber to help with scattering or even optical wavelength filtering—in the case of multiple wavelengths being propagated along the fiber.

Furthermore, the method of sensing the lost optical power can also be applied to fusion-spliced joints. This can be achieved by connecting around the fusion-spliced region a similar scattering material and a photodetector apparatus that can monitor the light-loss (and thus the light transmission) of an optical fiber link as a method of diagnostics during the lifetime of the installation. The method of sensing lost optical power can also can be applied to plastic optical fibers and optical waveguide materials (such as optical polymer layers on printed circuit board (PCB) materials), or any other region of a light conduit that may lose light power (such as a fiber that has exceeded its maximum bend radius).

In the embodiments described herein, a sensing apparatus installed along the path of the optical connectors is not only unobtrusive, it may remain undisturbed for very long periods of time. Therefore, in some embodiments, the monitoring circuit behind the optical connector does not have any power-source of its own. In alternative embodiments, small batteries may be designed into the sensing apparatus. In one embodiment, the monitoring circuit may be powered using localized RF (radio frequency) induced signaling—in the form of an RFID (radio-frequency identification) or other suitable circuit. As will be discussed further below, the RFID circuit may be used to provide power to the sensing apparatus and/or for wirelessly transmitting the sensed data from inside the optical connector towards one or more external devices. In this manner, it becomes possible to prevent the reliability of the monitoring circuit to impact the optical signal itself. For example, if the circuit malfunctions or the batteries completely lose charge, the performance of the optical link (and the optical connectors) can remain completely reliable and unchanged—as though it were a standard optical fiber cable and/or connector.

The applications for the described optical power monitoring system are numerous. For example, an application is during the initial installation of the cabling infrastructure. With possible cleanliness issues at the connector ends, or broken/cracked optical fibers, the installation technicians could use the system in conjunction with specially adapted hand-held scanners or meters that read-out the level of optical power measured.

In some embodiments, the internal photodetector may be momentarily powered-up and a measurement of the optical power lost through the connector may be taken, stored and transmitted from circuitry within the connector head. This is particularly useful as a quick and easy diagnostic to determine if the connector fiber-tip itself is dirty, broken or contaminated. An abnormal amount of optical power loss through the connector may signal that the connector needs to be cleaned or changed. In addition, the measured optical power may be derived from the leakage optical power from the connector itself. In this case, there is no additional power sampled or diverted from the main path of the optical signal, and the glass optical fiber is not modified or tampered with in any way, so its operating conditions remain identical to an optical connector without built-in power monitoring capabilities.

In some embodiments, to account for the very small amount of absolute optical power, the system may be capable of detecting down to the nanoWatts of optical power. For example, the lost optical power may be spread over the entire cylindrical outsides of the glass optical fiber and along several centimeters, e.g. about ten (10) cm, of length as well. As known to those skilled in the art, this means that a −0.5 dB of optical loss, equivalent to an absolute total loss of 11 mW for a 1 mW signal, is distributed over a surface area of approximately 2*π*r*h=2*π*(0.0125 cm)*(10.00 cm)=0.785 cm². This produces a power density of roughly 14 μW/cm². For a standard silicon p-n junction photodiode with a responsivity of 0.5 A/W, in order to generate a significant enough voltage, such as for example about 20 mV for a subsequent amplifier, over a 1 kOhm load, the current would have to be roughly 20 μA. This implies that at least 40 μW must be incident on the detector—which in turn implies a detector at least 3 cm² in area. Given a typical size detector head of about 1 mm², an incident light power of at least 4,000 μW/cm² would be required.

As will be discussed further below, several methods can be used to capture and direct optical power on a detector, and several types of detectors can be used. In one embodiment, a relay arrangement comprising a lens or imaging system is used to collect and focus the light. In another embodiment, a short image guide that can act as a light-guide and/or concentrator between the optical fiber and the photodetector is used. The types of detectors may then include, but are not limited to, silicon p-n junctions, charge-coupled devices (CODs) and avalanche photodiodes (APDs). Also, other photosensitive materials, such as organic photovoltaic materials may be sufficiently sensitive as well. In the case of a very small form-factor, a close-proximity optic (high-f-number) diffraction-grating may be used to capture the lost light. Alternatively, the detector may be a charge-coupled-device, with a very high optical sensitivity placed in close contact with the optical fiber. Such an arrangement may capture the lost light and generate an electrical signal proportional to the amount of optical power incident on each pixel of the CCD. In another embodiment, an organic material may also act as the photo-detecting medium, where the optical fiber is coated with layers along the length of the fiber or where the fiber is placed in a sufficiently long holder that has been patterned with the organic materials and electrodes. This arrangement may be made to produce a relatively large surface area to capture more of the leakage light.

In some embodiments, a scanner, in addition to extra circuitry and memory, such as flash memory, within the optical connector head, may be provided. The memory may be used to store one or more measurements of the leaked light detected by the photodetector provided as part of the optical monitoring device. The scanner may be designed with memory and read/write abilities to update a defined look-up table with specific fields stored within the optical connector monitoring system. The look-up table, similar to RFID look-up tables known to those skilled in the art, allows the scanner to, for example, read the serial number of the connector, enter new loss values, enter wavelength information, the type of optical fiber (multi-mode fiber (MMF) or single-mode fiber (SMF), e.g. OM3, SMF28, plastic optical fiber (POF), etc. . . . ), and the installation, date among others. An RFID tag may also be provided with active memory to store port and machine assignment numbers, and other helpful network infrastructure information. The RFID scanner may use RFID techniques to power-up and then read-out the information without touching the optical connector. This eliminates the need for power supplies (i.e.: batteries) within the system, and the optical connector head could then be sealed and made to withstand all environmental stresses. Similar connector monitors that use contact methods to power-up and relay information, perhaps using metal-contacts, may also be provided as a way to access information about the optical connectors as well.

During up-keep and maintenance of the installation, as pieces of equipment are changed, optical ports are upgraded, and new cables are laid, the RFID tagging system and the information stored inside the connector heads themselves allow the IT managers and technicians to easily track and organize the optical fiber cable links as well as help diagnose failures in the links.

Hand-held RFID scanners, used to monitor the optical power loss and the information stored at each connector end, may also be actively used during interconnect diagnosis issues, where the scanners would be used to measure abnormal optical power loss readings. For instance, a reading of no power may imply a broken fiber or dirty connection while a reading of a high power loss may imply a dirty connection and/or a scattering of optical power. The scanner or meter may also be configured to generate “good” and “bad” auditory signals, e.g. as a tone or beep, as the technician waves the scanner over the connector mating.

In addition, the information gathered by technicians using RFID or other suitable types of scanners may then be up-loaded into a database management software tool for organizing and maintaining the cable installation. For example, when an optical fiber cable must be located and replaced, the technician may simply wave the scanner over areas of connector monitors to locate the corresponding optical connector. The data collected by the scanner may map-out the network's cables, providing information on each of the links, their power budgets, their connection topologies, along with vendor information about the cables themselves. This database may be used to maintain the network and diagnose possible fault conditions. The data may later be downloaded to scanners for future work by technicians within the network installation.

In some embodiments, at least one absolute optical power measurement is made in the interconnect in order to determine if the connector is behaving well (e.g. Micro-Watts of power loss for Watts of input power) or badly (e.g. Micro-Watts of power loss for Micro-Watts of input power). This is done to account for the optical connector monitor's ability to only measure the leakage light, or the absolute loss component. The absolute optical power measurement may then be used as a reference or calibration power measurement. A set of algorithms may also be provided in the software platform to back-calculate the performance of a specific optical connector, either based on a power measurement of the laser module power or the direct power from one of the connectors in the link. The absolute power in the link may be established by using the average specifications of a laser transmit module (such as that from a small form-factor pluggable or SFP module). Given a sufficiently well-structured database, the optical power per optical port may also be available as part of the recorded information. In addition, levels of acceptable losses may be set to correspond to a customer's desired performance criteria, the types of optical fibers and connectors, the data rates (e.g. if a 10 Gbps signal requires more optical power than a 1 Gbps signal), or other parameters.

The scanner may also incorporate an optical power meter for absolute measurements used during the installations, as well as a wavelength meter to record measured wavelengths. It may also include a bar-code reader for ease of recording data, such as machine number, port number, etc, that would help keep track of the cables in the installation.

In some embodiments, the concept is also applied to the wavelengths of the light through the connector. By using ranges of optical filters over the photodetector elements, different portions of the detector can be made sensitive to the wavelength of light. In one embodiment, one or more optical filters may be positioned adjacent a corresponding photodetector and so as to surround at least a portion of the monitored optical fiber. If the optical monitoring device used to sense naturally leaked light from the optical fiber comprises several photodetectors, different wavelengths may then be detected using separate photodetectors each provided with a given filter sensitive to a given wavelength of light. Depending on the granularity of the filters, different light-bands (optical L-band, C-band, etc. . . . ) may be detected. Alternatively, detection may be performed in terms of typical optical wavelength technologies (e.g. 850 nm, 980 nm, 1310 nm, 1550 nm). Also alternatively, the system may detect the carrier wavelengths within a specific light-band given specifications issued by standardization bodies, such as the International Telecommunications Union (ITU), or the like. Numerous types of optical filters may be employed, from dielectric layers, to diffractive optical elements, to organic and inorganic materials that are sensitive to different incident wavelengths.

Moreover, the optical monitoring device described herein may be provided with other optical devices. For instance, any suitable optical device, such as a lens, a spherical or parabolic reflector including cylindrical versions of the same, may be positioned adjacent the optical fiber to guide the leaked light to one or more photodetectors provided in the monitoring device. In one embodiment, the optical device may be positioned so as to surround at least a portion of the optical fiber.

As will be discussed further below, in some embodiments, the concept may also be applied to arrays of optical fibers. For example, the monitoring technique disclosed herein may be applied to parallel optical fiber ribbons and MT (multi-terminal) style of optical connector ferrule. With parallel arrays of fibers terminated with MT ferrules, the same basic optical power loss is present as in single fiber ferrules. Similarly, the light loss extends several centimeters along the length of the optical fiber ribbon, where the lost light is absorbed into the polyimide or plastic coating that surrounds the glass fibers. The optical fibers in the ribbon tend to be spaced close together, nominally at a 250-micron pitch for 125-micron diameter glass fibers. The polyimide coating is normally color coded over each strand of glass optical fiber, but it remains relatively translucent, especially to wavelengths of interest, such as 850 nm, 1310 nm, or 1550 nm.

In such cases, an image guide and a method for slightly separating the optical fibers, such as an opaque epoxy poured over, and between, the fibers to cut-off the bleed-light of adjacent fibers, may be employed. Adapting a set of apertures that concentrate on every second fiber, in an interleaved fashion, will also separate the light from individual fibers. This light can then be imaged over a CCD chip to get multiple dots or strips over the area of the CCD, or other wide area set of photodetectors. When using a CCD device, an algorithm that can be used over the entire intensity profile of the array, based on the pixel intensity of a linear CCD chip, can then map the relative intensity of the lost power per channel. This can be correlated to the actual output power of the optical fibers, and levels of light intensity loss can then be monitored in an open or closed loop feedback—such as that used to monitor laser output power in optical transceiver devices.

In some embodiments, the optical power monitoring system and method may be used in feedback and control systems. By coupling the light from a laser into an optical fiber (using any one of several types of optical relay systems, lenses, etc. . . . ) inside the optical transceiver, and then using a fiber-to-fiber connector (including even a “non-connector” fusion-splicing of the fibers) immediately after the initial coupling of light, the amount of leakage light from the fiber-to-fiber connection can be used as a monitor for the light inside the transceiver itself. The leakage light can then be used, not only as a way of measuring the amount of optical power from the laser, but the optical power already inside the optical fiber.

All versions of optical transceiver, including single and multi-fiber modules, single-mode and multimode optical fiber waveguides, and a range of different optical wavelengths can all use the optical connector monitor within their form-factors as a low-cost, and simple alternative to the back-reflection method. Because the optical connector monitor assembly can be applied to the optical fiber cable itself to monitor leakage power, more complicated optical relay systems can be avoided, and simple monitor circuitry can be developed around the fiber cables independently of the transmitter/receiver functions of a transceiver module, with an interface to the main transceiver module via power, ground, and inter integrated-circuit (I2C) two-wire communications.

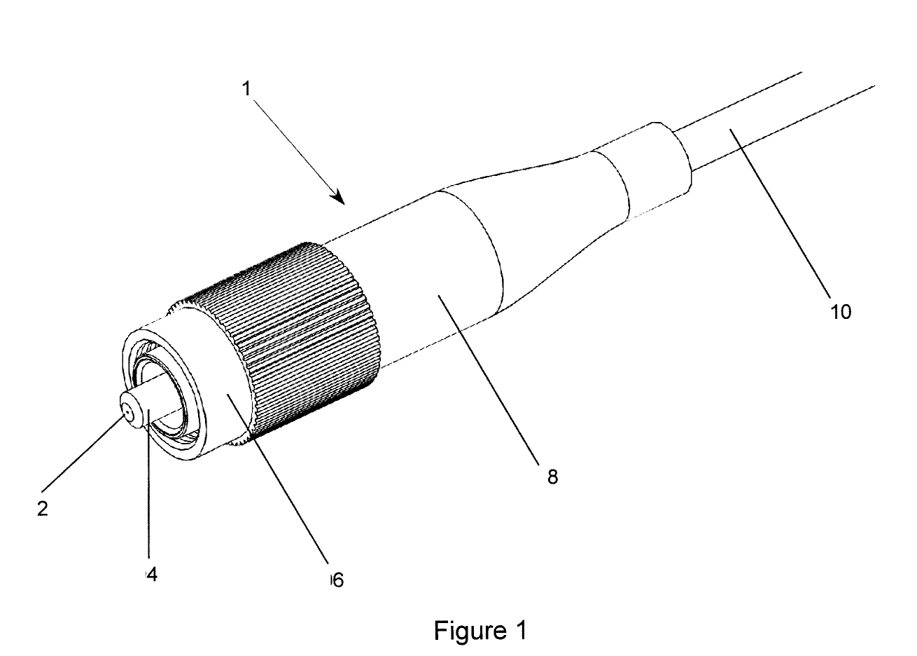

Turning now to FIG. 1, the type of optical fiber connector 1 shown in the figure, and which may be used to implement the above-described optical connector monitoring technique, is representative of one of many different types of optical connectors. The so-called FC-style optical connector 1 uses a central, precision fabricated, zirconia ferrule 4 with a small diameter hole through its center to locate a 125-um diameter glass optical fiber 2. The zirconia ferrule 4 and optical fiber 4 are polished at the tip (not shown) and are meant to be mated to another similar connector (not shown) for the proper, re-mating of glass fibers. The connector 1 itself has connector assembly features such as a front screw-barrel 6, which is used for attachment to connectors and bulk-heads. A back portion of the connector 1 is further provided with a rubber-boot assembly 8 used for strain-relief. The connector 1 is also usually part of a cable assembly with an outer protective sheath 10, inside which stranded nylon fibers may be used to maintain cable strength.

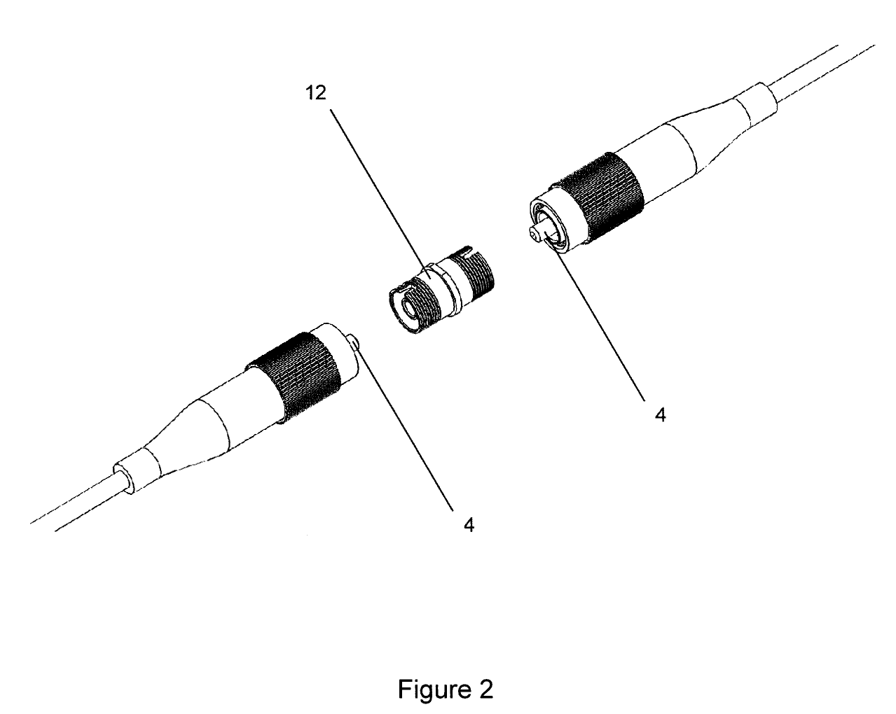

FIG. 2 illustrates an example of an FC-to-FC connector mating using an FC barrel adapter 12 and which may be used to implement the above-described optical connector monitoring technique. This is a standard means to join two cables (not shown) with a non-permanent, yet low optical loss, connection. For this purpose, an adapter 12 is provided, which may be made with a high-precision sleeve that locates the zirconia ferrules as in 4 of the two connectors so that their tips line up and point at each other.

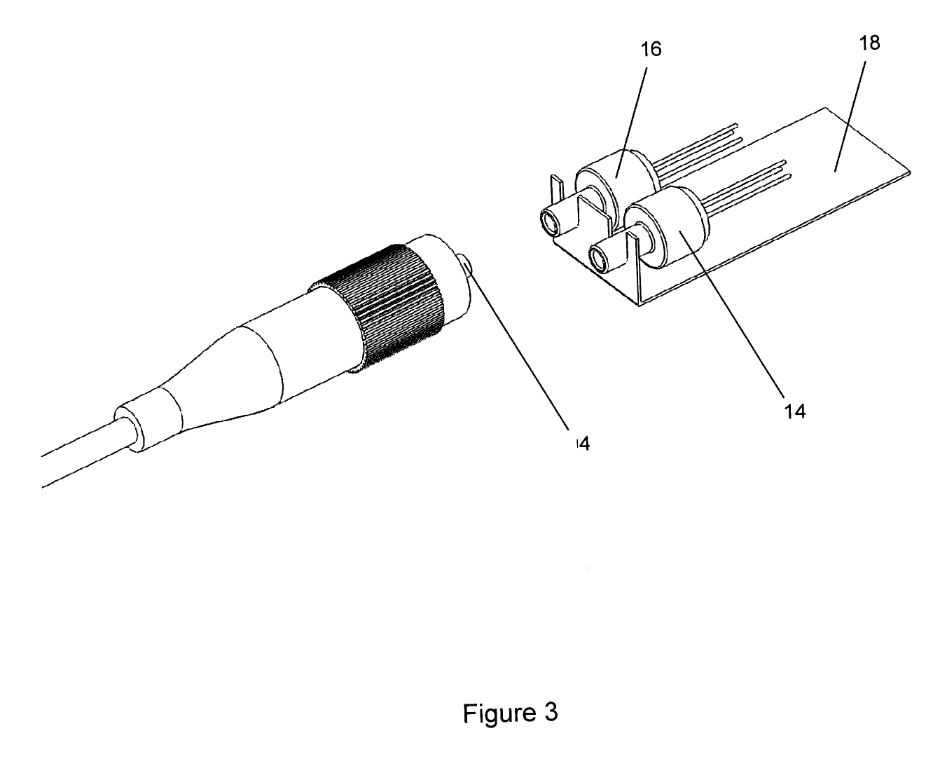

Other types of optical connections using FC (or similar) optical connectors may be used. A simplified version of one such type of connection, i.e. the connection between a cable of an FC connector and an optical transceiver (not shown), is illustrated in FIG. 3. In this embodiment, a laser (or photodetector) (not shown) may be packaged in a TO-4, 3-lead, package header (not shown). The laser is precision located in front of a lens (not shown) provided inside the package and both are aligned with the center of a barrel portion 14 of the package. Likewise, a photodetector may be aligned with a corresponding lens (not shown) and barrel 16. The FC connector 1 can then be inserted into the precision barrel and the zirconia 4 and fiber tip are then co-located at the focal point of the lens inside the TO-4 can 18 to optically couple light from the transceiver.

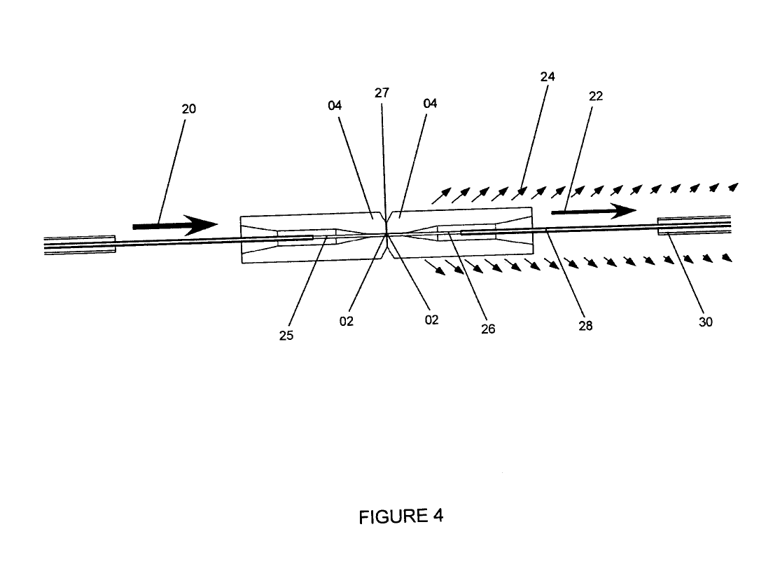

The transmission of optical power that occurs when two fiber tips are aligned and pointing directly at each other is shown in FIG. 4. This figure shows two, in-line, optical fibers as they would appear in cross-section, and without the encumbrance of the mechanicals of the connectors. FIG. 4 shows the cross-sections of the two zirconia ferrules 4 and their respective optical fibers 25, 26. For illustrative purposes, the first optical fiber 25 is shown from the left towards the right ending at the interface 27 between the fibers 25, 26. The second optical fiber 26 continues from the interface 27 towards the right. Remaining parts of the optical fiber cables comprise the polyimide (plastic) coating 28 that acts as a buffer layer surrounding the glass strand and the outside jacket 30 of the cable protection. The optical power in the first fiber 25 is represented by the larger dark arrow 20. This optical power is completely guided by the core of the optical fiber 25 and reaches the interface 27. At the connector interface 27 where the tips of the glass fibers 25, 26 meet, light emerges from the first-fiber 26. Under usual conditions, most of the light couples into the core of the second fiber 26, as represented by the smaller dark arrow 22. However, due to numerous physical reasons previously described, some light is not coupled into the core of the second fiber 26 at the interface 27. This portion of the light is leaked into the cladding and eventually out of the glass fiber 26 into the polyimide buffer layer, as illustrated by the decreasingly sized small arrows 24 along the second fiber 26. This leaked light 24 is normally only a very small portion of the overall light 22, and is usually completely absorbed and scattered after only a few centimeters. Using the monitoring technique described herein, this wasted light 24 can be used as a monitor of the total optical power inside the optical fiber 26.

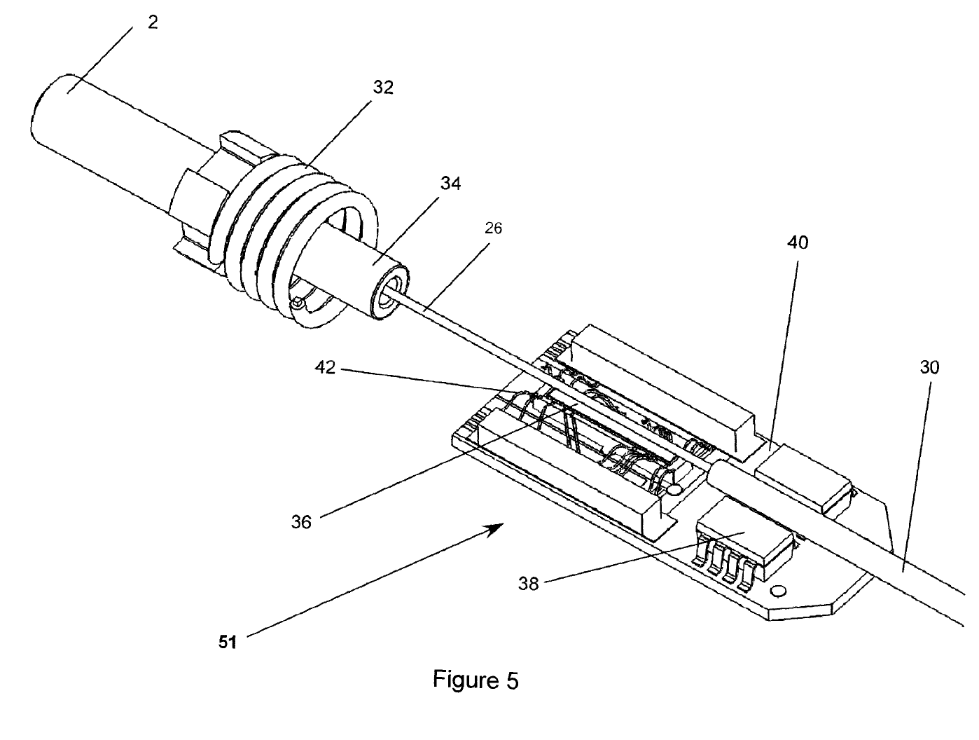

For this purpose, the apparatus used to capture the wasted light 24 illustratively comprises a circuit (not shown) that is essentially a photodetector sensitive enough to detect the low amount of optical power. However, the light 24 is leaked from the optical fiber 26 in a specific manner, i.e. the light 24 roughly follows the longitudinal direction of the glass fiber 26 and is radially distributed along the length of the zirconia guiding cylinder or ferrule 4. As a result, the detector is designed to have a sufficiently long and narrow active region and can be aligned along the direction of the optical fiber, e.g. optical fiber 26, as shown in FIG. 5 using a long, narrow detector chip 36.

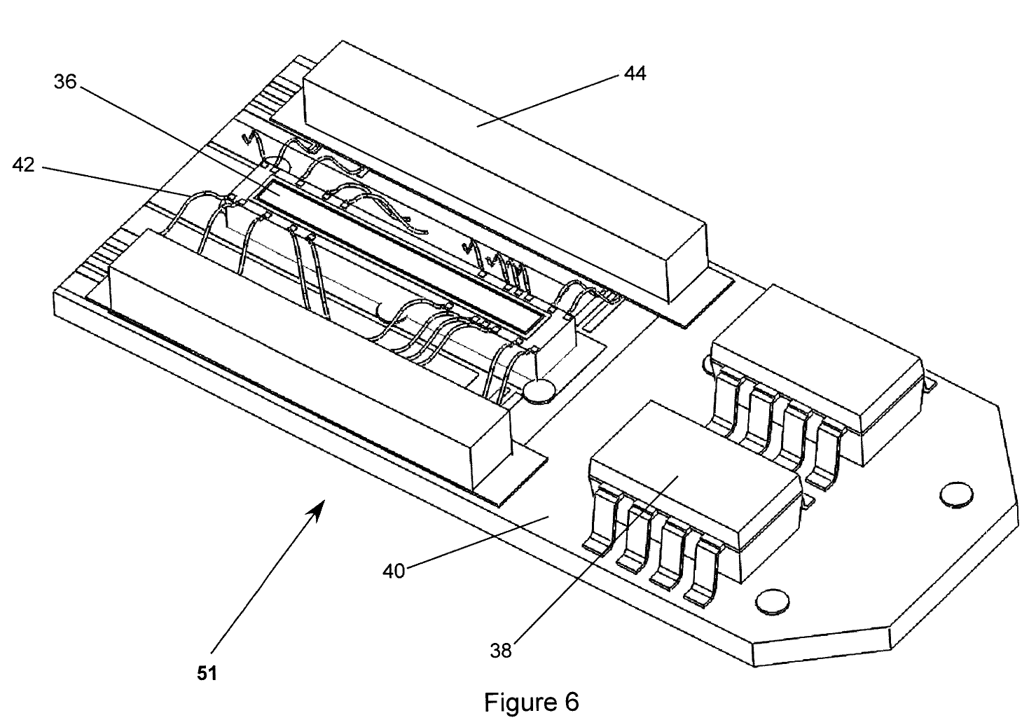

The practical application of this type of detection apparatus is to be able to fit it into more standard types of optical connector mechanical housings or casings. Therefore, in one embodiment the detector circuit used is sufficiently small in size to accommodate standard optical connector housing sizes, albeit with minor modifications to the connector housing. FIG. 5 provides a size reference for a circuit paddle-card 51 used for the detection apparatus relative to the actual inner mechanics of the standard FC connector 1, i.e. relative to the zirconia ferrule 4, a retention spring 32, and an inner barrel assembly 34. These parts are intrinsic to the standard FC connector and remain part of the assembly. FIG. 6 shows a close-up of the circuit paddle-card 51 that incorporates the photodetector chip 36, wirebonds 42, a printed wiring board 40, and some representative biasing circuit chips in the form of standard SOT-24 IC packages 38. The circuit paddle-card 51 further comprises a set of vertical stand-offs or separators 44 that can help locate the photodetector relative to the optical fiber 26 and to other parts of the connector assembly.

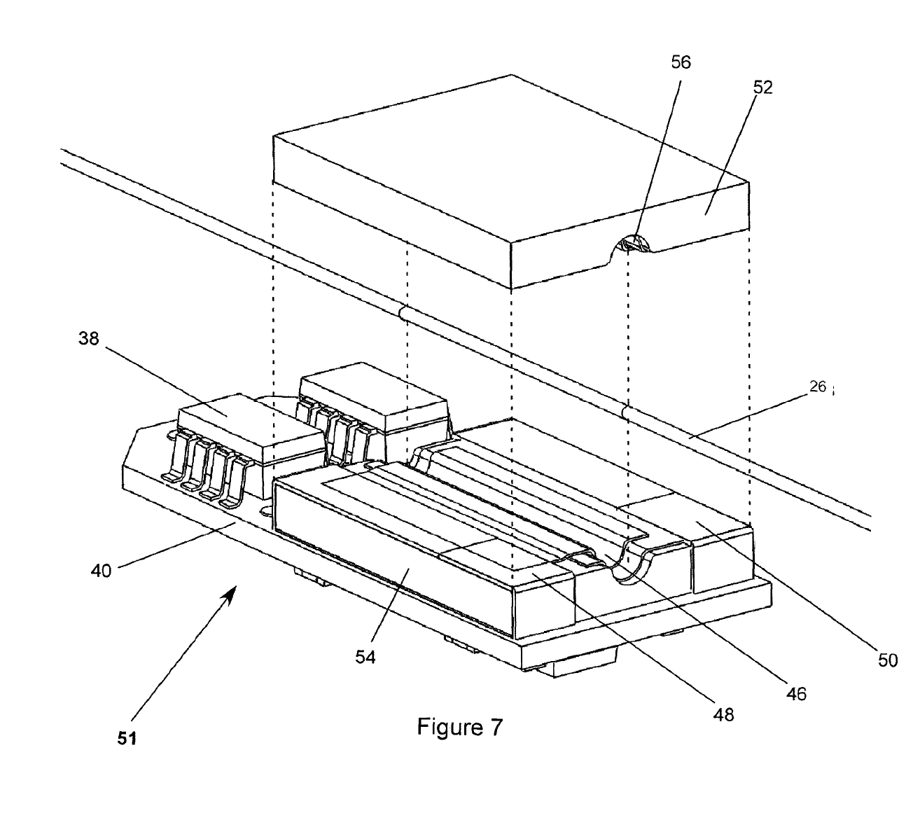

An alternative photodetector design may be to capture a large portion of the scattered optical power by effectively depositing a photo-detecting material around a certain length of the cylindrical surface of the optical fiber 26. This may be done using a photosensitive polymer material that may coat the fiber 26 along a certain length thereof. Anode and cathode electrodes may then be patterned near the connector end. As shown in FIG. 7, an alternative photodetector design may comprise a first or upper holder member 52 and a second or lower holder member 54, which can be arranged relative to one another so as to define a space (not shown) between inner surfaces thereof. The so-defined space may then receive therein the optical fiber 26. The first and second holders 52, 54 may each be a large-area patterned photodetector. Also, the second holder 54 may comprise an anode side 46 with a corresponding electrode 48 while the first holder 54 may comprise a cathode side 56 with a corresponding electrode 50 provided on the holder 54. A photosensitive polymer coating may further be applied to the inner surface of the second holder 54 and to the inner surface of the first holder 52. The overall assembly may then be solder reflowed to the circuit paddle-card 51 along with the other IC packages and take the place of the photodetector chip 36 shown in FIGS. 5 and 6.

When coupling the detector circuit to the optical fiber as in 26, the glass of the optical fiber illustratively remains untouched. Indeed, no splitters, taps, extreme bends, or other mechanisms to force leakage light from the fiber are used. As such, the reliability of the glass fiber and the connector interface may not be compromised. The glass fiber as in 26 within the connector housing is illustratively located such that it passes longitudinally over the photodetector chip (reference 36 in FIG. 6) or through the center of the detector block formed by the first and second holders (references 52 54 of FIG. 7) and through a rounded hollow trench made up by the detection block halves 52 and 54. As a result, if, for some reason, the detector circuit malfunctions and cannot be used, the reliability of the optical connector 1, which then acts as a standard optical connector, is not compromised.

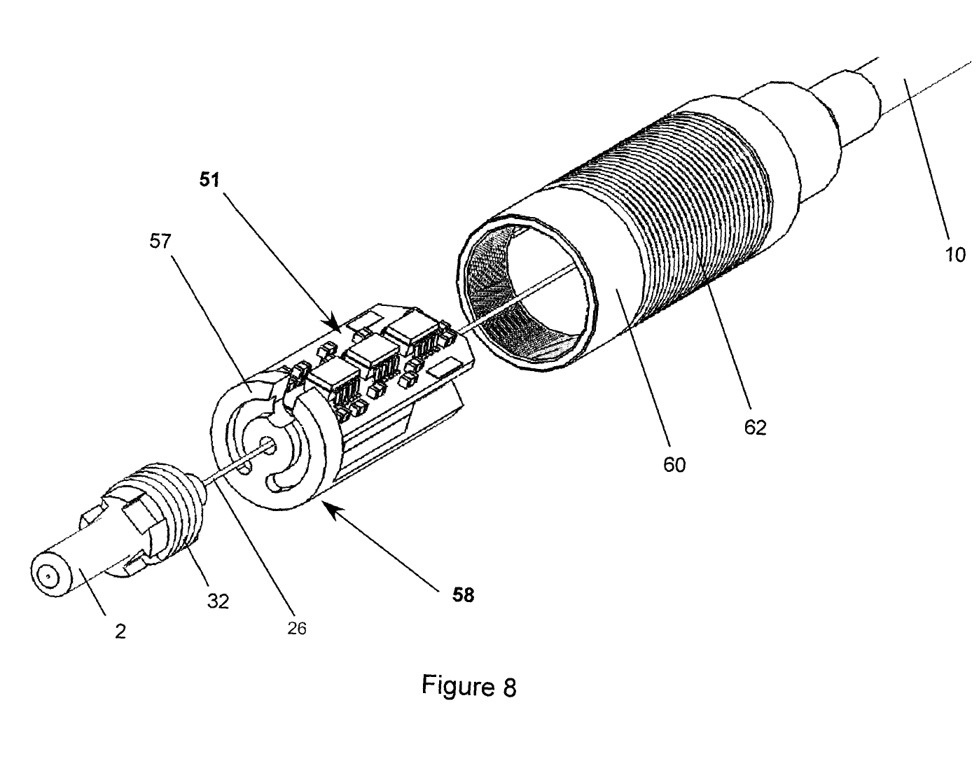

FIG. 8 further illustrates modifications that may be implemented for including the above-mentioned detection circuit into an FC connector. The detection unit 58 shown includes the circuit paddle-card 51 (with all the subcomponents discussed above, including the photodetector), along with a specially designed supporting member, such as an insertion slug 57. The insertion slug 57 carries the circuit paddle-card 51 and allows the optical fiber 26 to be inserted through the middle (not shown) of the insertion slug 57 and over the photodetector area during the manufacturing process used to build the connector 1. FIG. 8 also shows how the connector housing may be modified to provide a detector barrel 60 along with an external coil or wire winding 62 that could be used in a manner similar to RFID discussed above. For instance, the coil 62 may be an electromagnetic field coil configured to modulate an external magnetic field in order to wirelessly transfer information. In this embodiment, there is no internal power source for the detector circuit. Instead, the inductive coil 62 around the outside of the detector barrel 60 communicates with the detector circuit using an external (e.g. hand-held) device that could act as an RFID reader. In addition to this, IC packages (reference 38 in FIG. 5) may also contain RF circuits of a wireless transmitting apparatus required for RFID or other suitable wireless transmission along with additional memory and control features.

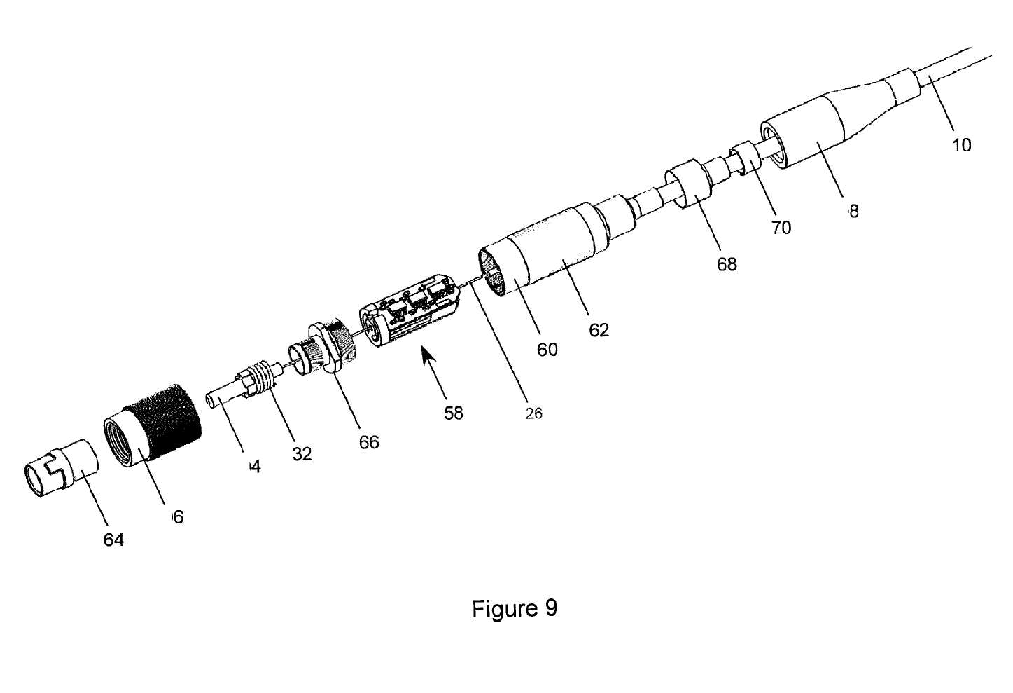

An exploded view of an FC-style optical connector with an optical monitoring device is shown in FIG. 9. This figure highlights the components used and also shows that this type of optical connector fits within the standard dimensions of typical optical connector housings. The exploded view shows the front guide-barrel 64 of the FC-connector 1, the front screw barrel 6 of the FC-connector 1, the zirconia ferrule 4 that holds the optical fiber 26, and the inner retention spring 32 of the FC-connector 1. Next, the back guide barrel 66 is provided, which adapts to the sensor assembly 58 with the optical fiber 26 passing through the middle of the sensor assembly 58. The barrel cover 60 for the sensor assembly 58 along with the RF wire coil 62 are then screwed together with the back guide barrel 66. The optical fiber protective cable 10 is then joined to the barrel cover 60 using a first crimp collar 68 and a second crimp collar 70. The back rubber boot 8 is then pushed over the back of the connector assembly and holds on to the back portion of the barrel cover 60.

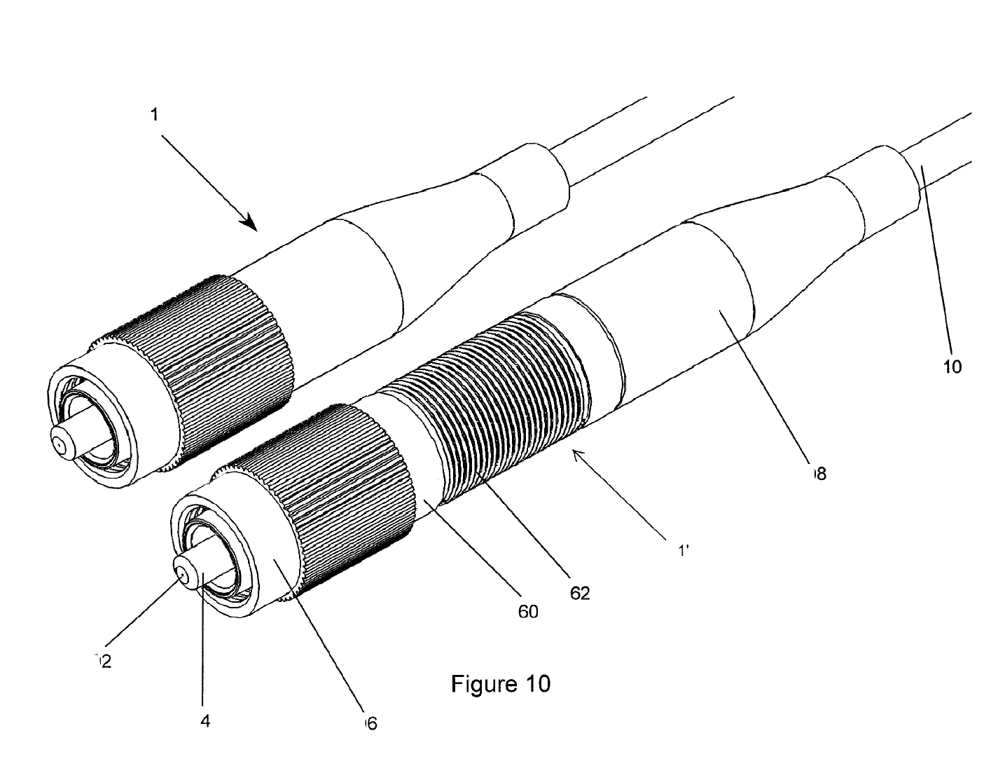

FIG. 10 illustrates the relative difference in length of the standard FC-connector 1 and the RFID enabled, optical sensor, connector monitor FC-connector 1′. It can be seen that the FC-connector 1′ is slightly longer than the standard FC-connector 1.

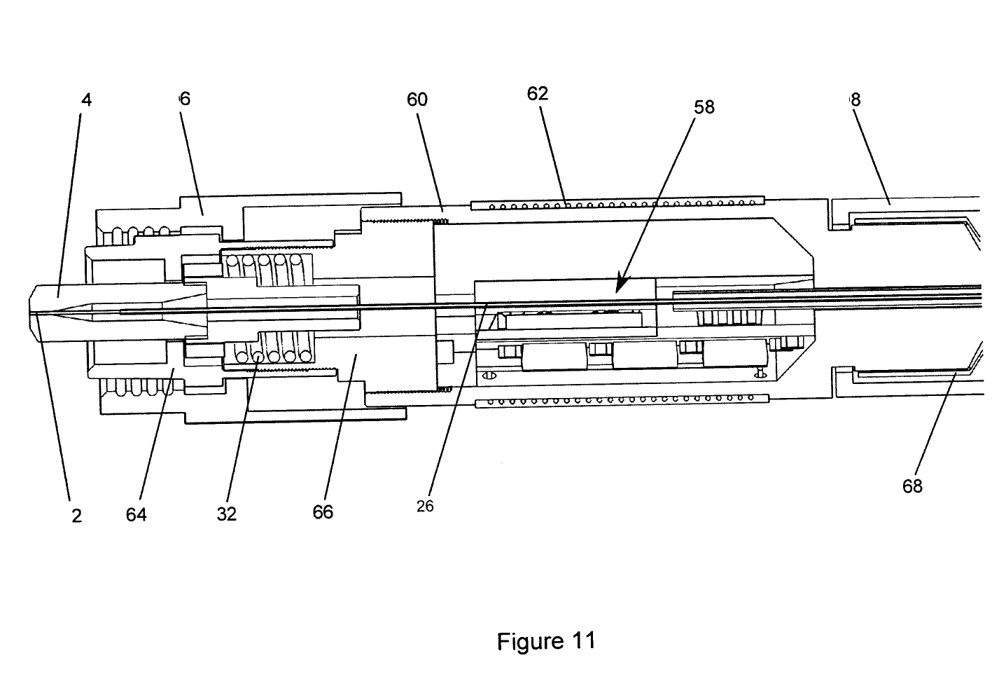

FIG. 11 illustrates how the optical fiber 26 passes through the entire connector (reference 1′ in FIG. 10) undisturbed until it gets to the tip of the zirconia ferrule 4. The coupled light that is launched into the tip 2 of the optical fiber 26 passes along the fiber 26 as it would in a standard connector (reference 1 in FIG. 10). The lost light, due to imperfections in the coupling at the tip 2 and/or to defects in the optical fiber 26, is directed along the fiber 26 but scattered out of the fiber 26 in the region of the sensor assembly 58. The photodetector within the sensor assembly 58 then picks up the scattered optical power, amplifies it, and uses other circuit components within the sensor assembly 58 to transmit the detected information by way of the RF coil 62.

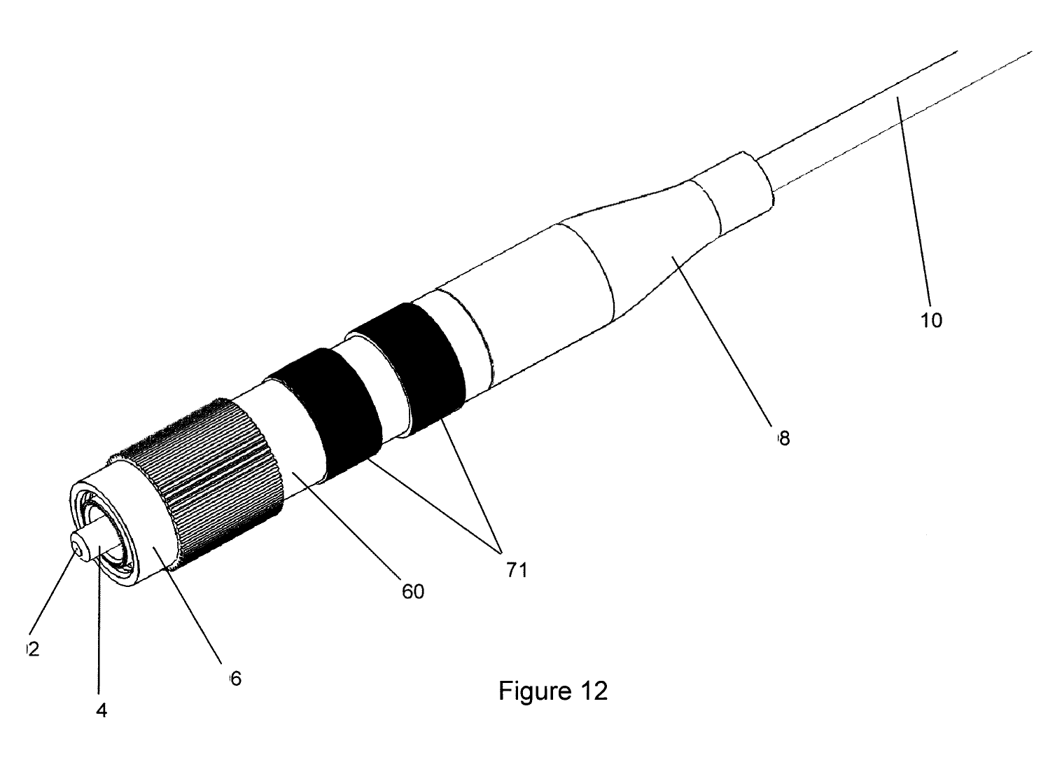

As an alternative means over the RFID method for powering-up and for wirelessly transmitting the data from inside the connector 1′ to one or more external devices, two or more metallic conduction elements 71 may be provided on the connector's housing. The conducting elements 71 may be implemented as elements having any suitable shape or form, such as rings or points, and may be used as physical electrical contacts for electrical power and/or signaling, as shown in FIG. 12. As a result, the complexity of the connector 1′ can be reduced with no RF circuitry being needed as would be the case when using the above-mentioned wireless RFID technique. However, the ease of data collection and communication with the connector 1′ may become more difficult. In other embodiments, an electrical bus (not shown) may be provided along the optical fiber protective cable (reference 10 in FIG. 9). Using such a bus, e.g. a low-speed bus, a measurement of the leaked light detected by the optical monitoring device, e.g. the photodetector within the sensor assembly 58, can be relayed to an external device. Electrical power may also be provided to the optical monitoring device using the electrical bus.

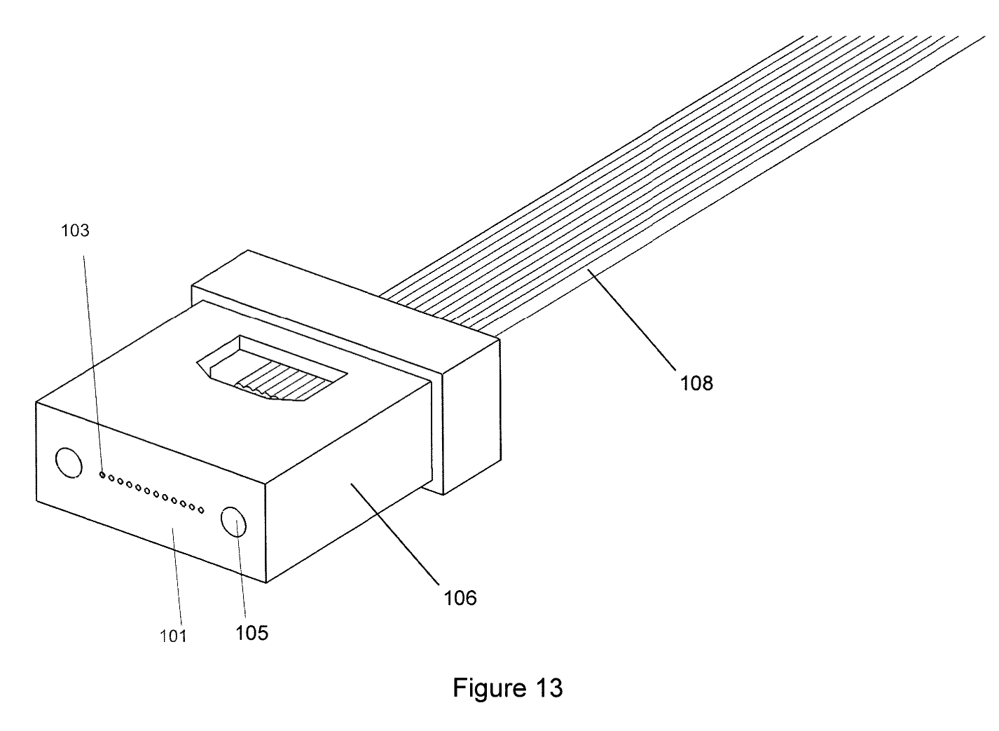

Some applications may require the monitoring of more than one optical fiber at the same time. An example of a multi-fiber connector that can also use the unobtrusive methods described above to detect leakage optical power is the “MT” style of connector (multi terminal connector) shown in FIG. 13. In this figure, a parallel optical fiber ribbon 108 is shown, along with an MT ferrule 106 into which the optical fibers, e.g. twelve 125-um diameter fibers (not shown) pitched at 250-um, are set and glued. The front end 101 of the MT ferrule 106 is then polished flat, resulting in a smooth polish of the tips 103 of the twelve optical fibers, between two dowel pin holes 105. The twelve glass fibers may further be protected with a polyimide buffer layer (not shown) that overcoats the glass fibers and keeps the fibers together in the ribbon 108. The ribbon 108 is also usually color-coded, such that each fiber in the ribbon 108 has its own color.

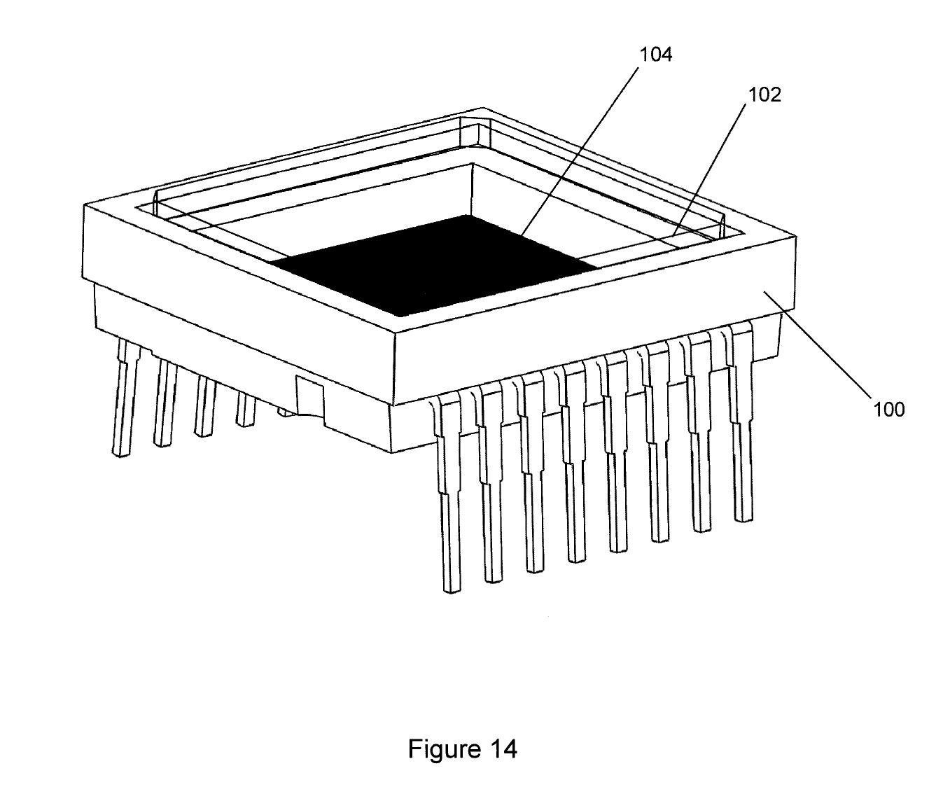

By using a sensitive photo-detecting element (not shown), the leakage light can be observed escaping each fiber of the ribbon 108 just after the MT ferrule 106 when light has been coupled into the fiber array. For this purpose, a photodetector array chip, e.g. a charge-coupled device (CCD) array chip, can be used to detect the light over the width of the ribbon 108. As shown in FIG. 14, a CCD chip 104 in a leaded carrier 100 can be used. Although an optical system, such as a lens (not shown), is typically used to image onto the surface of the CCD chip 104, in one embodiment, in order to keep costs to a minimum, and use as many off-the-shelf parts as possible, the glass cover plate 102 may be removed.

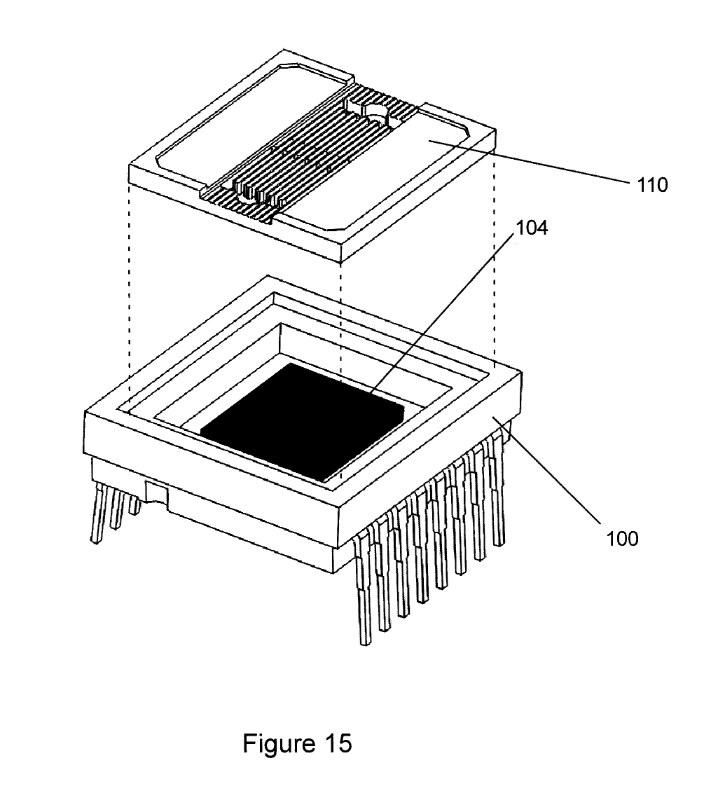

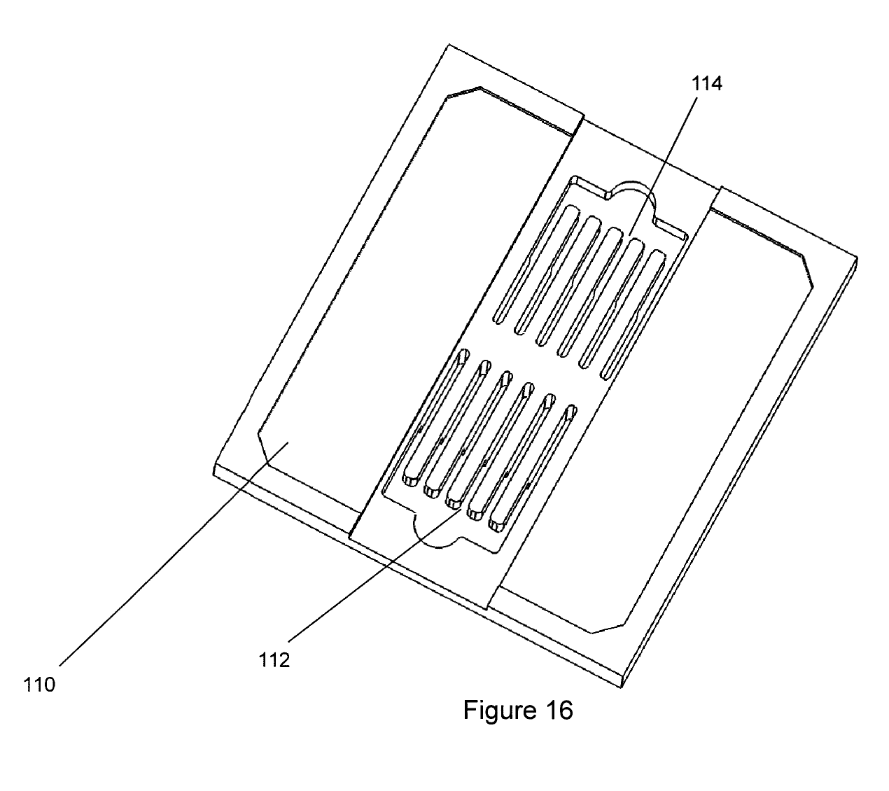

The glass cover 102 may then be replaced with a custom designed slotted, opaque, plate 110 that fits the leaded chip carrier 100, as shown in FIG. 15. The slotted plate 110 may be placed over the CCD chip 104. The slotted plate 110, as shown in FIG. 16, is illustratively a simple aperture design comprising a first set of grooves and/or slots (not shown) for the even-numbered optical fibers 112 in the ribbon 108 and second set of grooves and/or slots (not shown) for the odd-numbered optical fibers 114 in the ribbon 108. Such a design allows to distinguish the light leaked from each of the twelve optical fibers, and this without a significant amount of optical crosstalk. The design also allows a relatively easily manufactured slotted plate 110 to be made, since the mechanical tolerances on the slots need not be high.

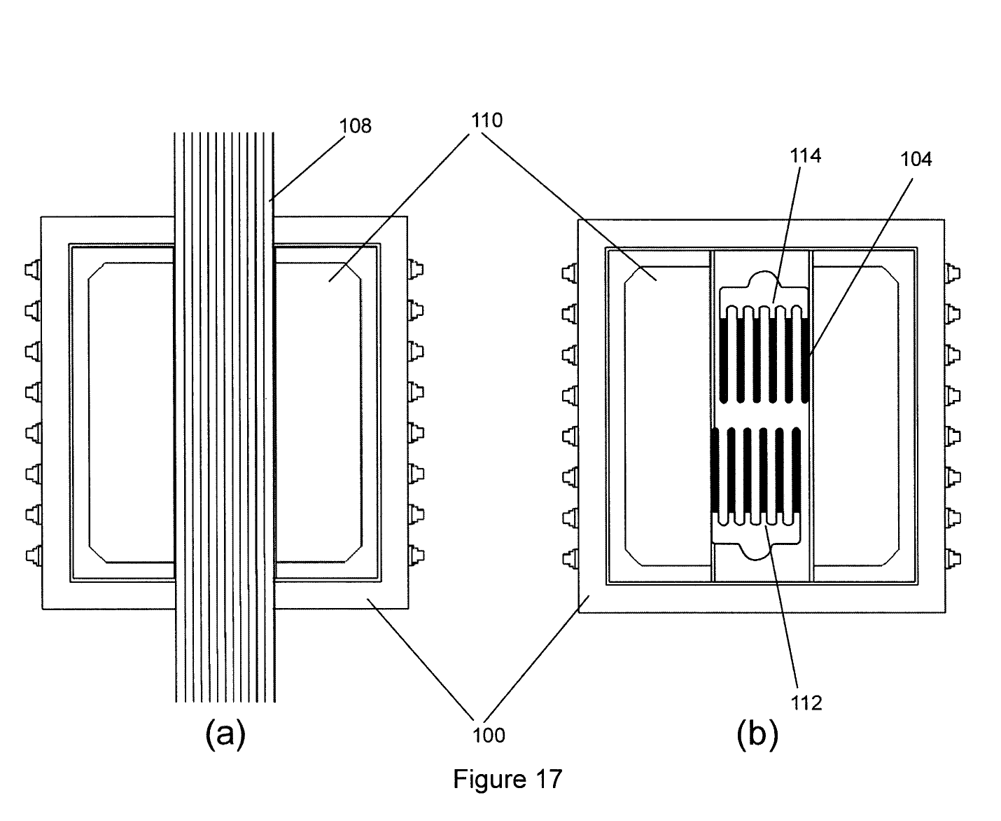

As shown in FIG. 17 (a), a view from the top of the leaded carrier package shows the optical fiber ribbon cable 108 placed onto the slotted plate 110 and over the CCD chip 104. In FIG. 17 (b), the same view is given, except without the optical fiber ribbon cable 108.

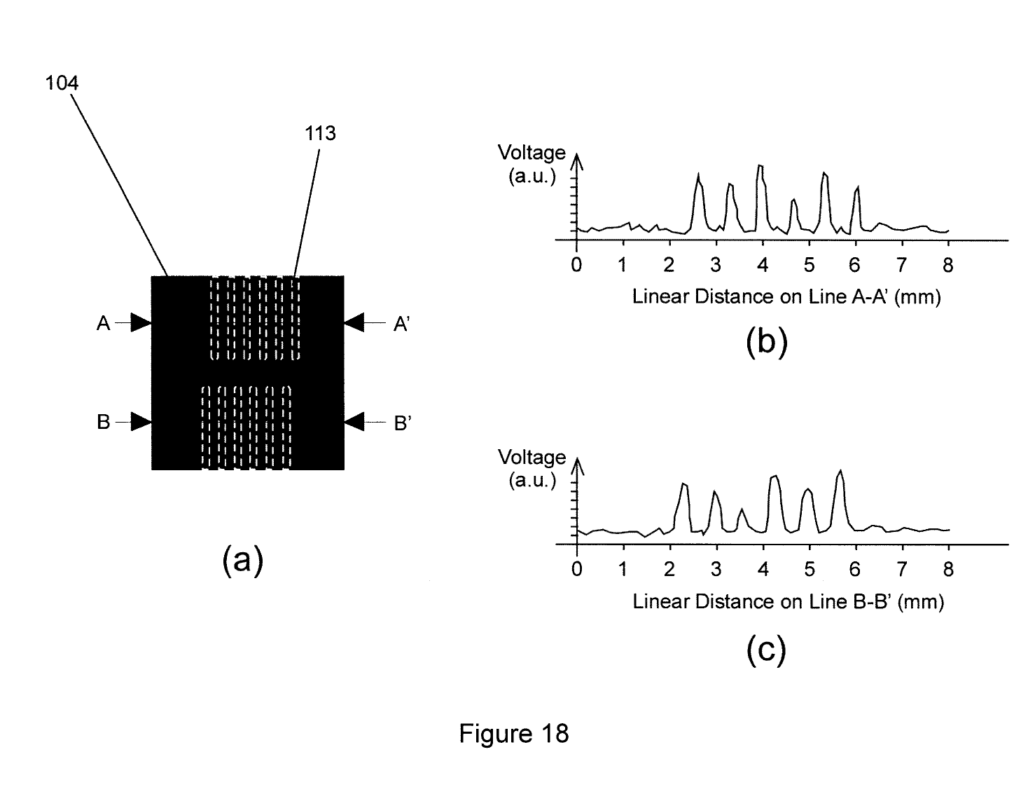

FIG. 18 shows a method for reading out high and low optical power values. This may be achieved due to the misalignment tolerances of the slotted plate 110 and the optical fiber ribbon 108 by scanning two straight-lines over the CCD chip 104. In particular, line A-A′ is drawn for the odd-numbered fibers (reference 114 in FIG. 16) and line B-B′ for the even-numbered fibers (reference 112 in FIG. 16). The region over the CCD chip 104 shown in a dashed line 113 indicates the area of the CCD chip 104 where light leaked from the fibers 112, 114 is incident and imaged on the CCD chip 104. A voltage scan of the CCD array chip 104 along either of the two lines A-A′, B-B′ is then shown in FIGS. 18 (b) and (c). It can be seen that the voltages, given sufficiently well aperture light through each of the slots, correspond to the leakage light in each of the optical fibers 112, 114 in the ribbon 108.

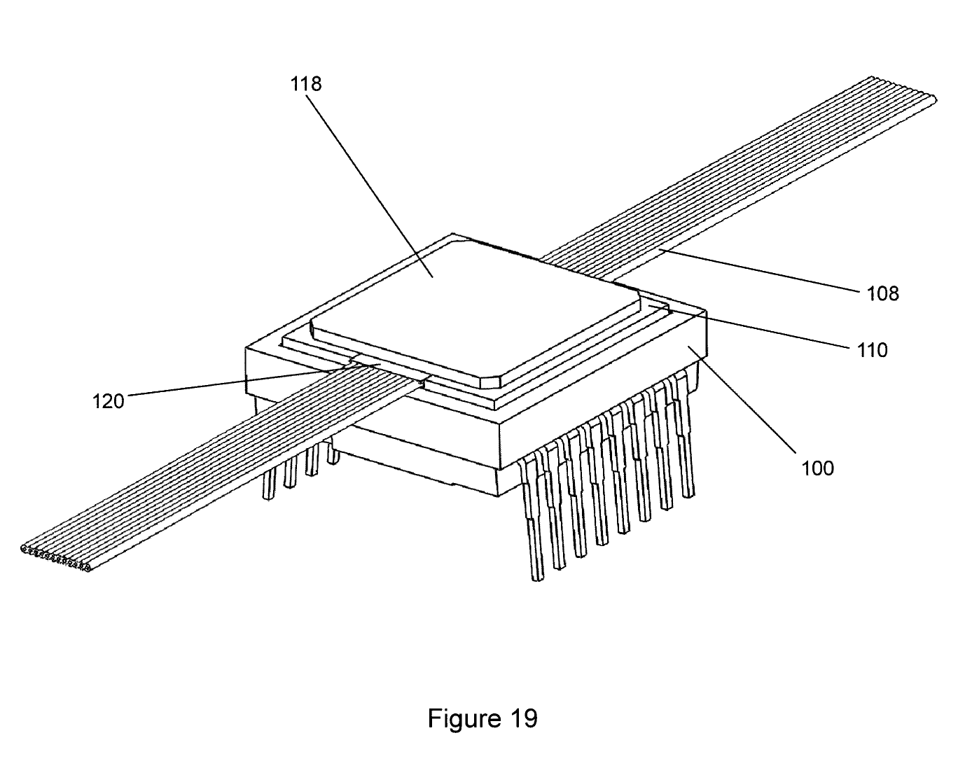

FIG. 19 shows the overall assembly comprising the optical monitoring device (not shown) coupled to the optical fiber ribbon 108. The optical fiber ribbon 108 illustratively remains completely intact and is placed over the slotted plate 110. A compliant, e.g. sponge-like or other suitable, material 120 may be used with the opaque cover 118 and pressed into a compression (or latched) fitting over the package.

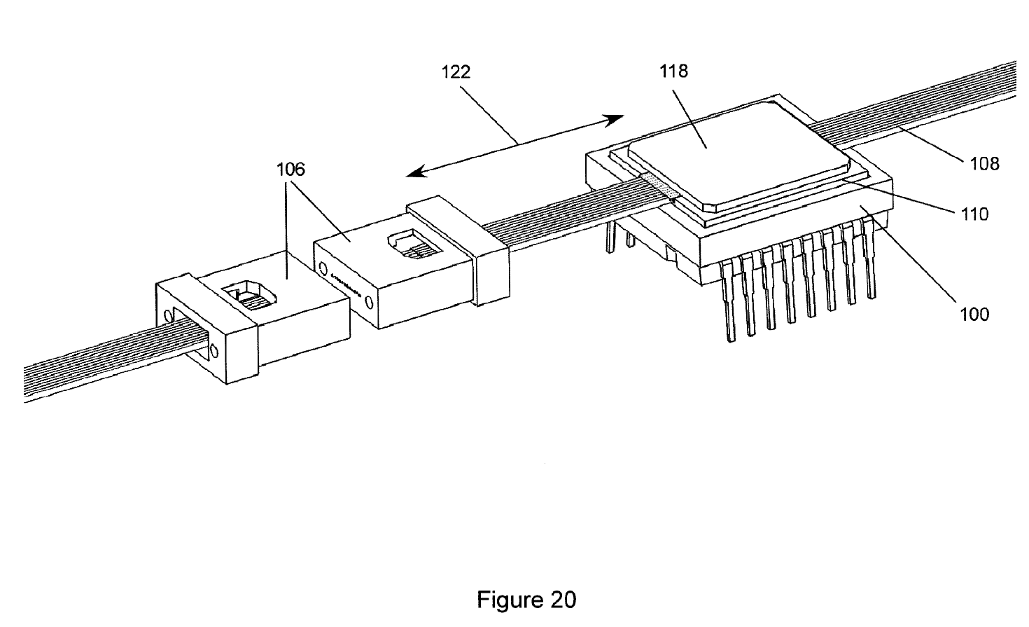

The final assembly for the MT-type of connector is then shown in FIG. 20. The figure shows two mated MT ferrules as in 106, where light passes from the left MT ferrule towards the right MT ferrule. The connector monitor is placed a relatively short distance 122 away from the ferrules 106. The monitoring package can then be suitably powered-up and the signals from the CCD chip (reference 104 in FIG. 18) can be processed to determine the relative amount of optical power leaked by each optical fiber in the ribbon.

Using an avalanche photodiode (APD) as the photodetector to implement the above-mentioned monitoring technique, it further becomes possible to measure a rate at which bits are transmitted along a given optical fiber in addition to detecting the amount of power escaping the fiber. This may be achieved using a sufficiently powerful and sensitive avalanche photodiode in proximity of the fiber's light leakage. As known to those skilled in the art, such an avalanche photodiode exploits the photoelectric effect to convert light into electrical signals. The bit rate of the electrical signals may then be determined, thereby providing an indication of a rate at which information (e.g. bits of data) travels through the fiber.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. An optical connector comprising:
a casing having a hollow body and at least one aperture at one end thereof;
at least one optical fiber having an outer surface and a fiber end and extending inside the hollow body of the casing along a longitudinal direction thereof;
a connector assembly supporting the at least one optical fiber in the casing and aligning the fiber end with the at least one aperture; and
an optical monitoring device comprising at least one photodetector in proximity to the fiber end of the at least one optical fiber and adapted to detect naturally leaked light from the fiber end.

2. (canceled)

3. (canceled)

4. The optical connector of claim 1, further comprising a coating on the at least one optical fiber that captures and scatters at least a portion of the naturally leaked light at a plurality of angles along the outer surface of the optical fiber.

5. The optical connector of claim 1, wherein the optical monitoring device is fitted inside the hollow body of the casing.

6. The optical connector of claim 1, wherein the optical monitoring device comprises a circuit board and the at least one photodetector comprises an elongate photodetector chip mounted on the circuit board, the photodetector chip positioned adjacent the at least one optical fiber and aligned along a length thereof.

7. The optical connector of claim 1, wherein the at least one photodetector comprises a first photodetector member having a first inner surface and a second photodetector member having a second inner surface, the first photodetector member and the second photodetector member arranged to define between the first inner surface and the second inner surface an elongate space receiving therein the at least one optical fiber.

8. The optical connector of claim 7, wherein the first photodetector member has a first coating on the first inner surface and the second photodetector member has a second coating on the second inner surface, the first coating and the second coating capturing and scattering at least a portion of the naturally leaked light at a plurality of angles along the outer surface of the at least one optical fiber.

9. The optical connector of claim 1, wherein the at least one optical fiber comprises a fiber ribbon comprising an array of parallel optical fibers, the optical monitoring device adapted to detect the naturally leaked light from alternate ones of the parallel optical fibers.

10. (canceled)

11. (canceled)

12. The optical connector of claim 9, wherein the at least one photodetector comprises a photodetector array chip covered by a plate having formed therein a plurality of parallel grooves each receiving a corresponding one of the parallel optical fibers, the naturally leaked light from the alternate ones of the parallel optical fibers imaged on the photodetector array chip.

13. The optical connector of claim 12, wherein the parallel optical fibers are numbered and further wherein the plate has formed therein a first set of the plurality of parallel grooves receiving even-numbered ones of the parallel optical fibers and a second set of the plurality of parallel grooves receiving odd-numbered ones of the parallel optical fibers.

14. The optical connector of claim 1, further comprising at least one electromagnetic field coil provided on the casing, the at least one electromagnetic field coil configured to modulate a magnetic field to at least one of wirelessly provide electrical power to the optical monitoring device and wirelessly transmit the measurement.

15. The optical connector of claim 1, further comprising at least one electrical contact provided on the casing and configured to at least one of provide electrical power to the optical monitoring device and transmit the measurement by physical contact.

16. The optical connector of claim 1, further comprising a protective cable surrounding the at least one optical fiber and an electrical bus coupled to the protective cable, the electrical bus configured to at least one of provide electrical power to the optical monitoring device and transmit the measurement.

17. The optical connector of claim 1, wherein the optical connector comprises at least one optical device positioned adjacent the fiber end and adapted for guiding the naturally leaked light towards the at least one photodetector.

18. The optical connector of claim 1, wherein the optical connector comprises at least one optical filter positioned adjacent the fiber end and the at least one photodetector, the at least one optical fiber sensitive to a given wavelength of light and adapted to cause the at least one photodetector to detect the given wavelength of the naturally leaked light.

19. (canceled)

20. An optical monitoring device for monitoring optical power in an optical connector, the device comprising
a supporting member adapted to receive at least one optical fiber of the optical connector, the at least one optical fiber having an outer surface and a fiber end; and
at least one photodetector secured to the supporting member, the at least one photodetector adapted to be positioned in proximity to the fiber end of the at least one optical fiber and to detect naturally leaked light from the fiber end.

21. The optical monitoring device of claim 20, further comprising a memory for recording a measurement of the naturally leaked light and a wireless transmitting apparatus for transmitting the measurement.

22. The optical monitoring device of claim 20, wherein the supporting member is adapted to be fitted inside the hollow body of the casing of the optical connector with the at least one optical fiber received on the supporting member extending inside the hollow body of the casing along a longitudinal direction thereof.

23. The optical monitoring device of claim 20, wherein the at least one photodetector comprises an elongate photodetector chip adapted to be positioned adjacent the at least one optical fiber and aligned along a length thereof.

24. The optical monitoring device of claim 20, wherein the at least one photodetector comprises a first photodetector member having a first inner surface and a second photodetector member having a second inner surface, the first photodetector member and the second photodetector member arranged to define between the first inner surface and the second inner surface an elongate space adapted to receive therein the at least one optical fiber.

25. The optical monitoring device of claim 24, wherein the first photodetector member has a first coating on the first inner surface and the second photodetector member has a second coating on the second inner surface, the first coating and the second coating adapted to capture and scatter at least a portion of the naturally leaked light at a plurality of angles along the outer surface of the optical fiber.

26. The optical monitoring device of claim 20, wherein the at least one photodetector comprises a photodetector array chip and the supporting member comprises a plate covering the photodetector array chip, the plate having formed therein a plurality of parallel grooves each receiving therein a corresponding one of parallel optical fibers, the naturally leaked light from alternate ones of the parallel optical fibers imaged on the photodetector array chip.

27. A method for monitoring optical power in an optical connector, the method comprising:
transmitting light through at least one optical fiber having an outer surface and a fiber end and extending inside a hollow body of a casing of the optical connector along a longitudinal direction thereof, at least part of the light traveling through the at least one optical fiber naturally leaked from the fiber end; and
detecting the naturally leaked light from the fiber end of the at least one optical fiber using at least one photodetector placed in proximity thereto.

28. The method of claim 27, further comprising recording a measurement of the naturally leaked light in a memory and transmitting the measurement to one or more receiving apparatuses using a wireless transmitting apparatus coupled to the at least one photodetector.

29. The method of claim 27, wherein transmitting light through the at least one optical fiber comprises transmitting light through an array of parallel fibers and further wherein detecting the naturally leaking light comprises detecting the naturally leaked light from alternate ones of the parallel optical fibers imaged on the at least one photodetector.

30. The method of claim 27, further comprising detecting a rate at which data bits are transmitted through the at least one optical fiber using an avalanche photodiode as the at least one photodetector.
